(19) United States
(12) Patent Application Publication
(10) Pub. No.: US 2012/0301594 A1
(43) Pub. Date: Nov. 29, 2012

(54) ROASTED GREEN TEA BEVERAGE PACKED IN A CONTAINER

(75) Inventors: Keisuke Numata, Makinohara-shi (JP); Kazunobu Tsuru, Makinohara-shi (JP); Fuyuki Fujihara, Makinohara-shi (JP)

(73) Assignee: ITO EN, LTD.

(21) Appl. No.: 13/522,085

(22) PCT Filed: Dec. 22, 2010
(86) PCT No.: PCT/JP2010/073107

§ 371 Date: Jul. 13, 2012

(30) Foreign Application Priority Data
Jan. 29, 2010 (JP) 2010-019138

(51) Int. Cl. A23F 3/00; A23F 3/38

(52) U.S. Cl. 426/597

(57) ABSTRACT

Provided is a roasted green tea beverage packed in a container, which has a noticeable roasted aroma and a rich, astringent and yet light flavor and tastes good even in a cold state. The roasted green tea beverage packed in a container is characterized by: the caffeine concentration being less than 90 ppm; the concentration of saccharides, i.e., the sum of reducing saccharides and non-reducing saccharides, being 60-220 ppm; the ratio of the non-reducing saccharide concentration to the reducing saccharide concentration (non-reducing saccharides/reducing saccharides) being 5.0-15.0; the gallic acid concentration being 20-80 ppm; and the pH being 5.5-6.3.

### TECHNICAL FIELD

The present invention relates to a roasted green tea beverage packed in a container that contains an extraction of a tea that is extracted from roasted green tea leaves as a major component, which is filled into a plastic bottle, a can, or the like.

### BACKGROUND ART

A beverage of roasted green tea that is extracted from roasted tea leaves has unique fragrance, and in recent years, is on sale as a roasted green tea beverage packed in a container, which is filled into a PET bottle or the like.

However, a roasted green tea beverage contains caffeine, which is known to have excitatory action or the like, and cause headache, insomnia, or the like. Particularly, in the case where a roasted green tea beverage is ingested by infants, elderly people, pregnant women, or the like, there may be a concern of influence of caffeine on them.

Therefore, a tea beverage having reduced content of caffeine attracts attention in recent years.

For example, Patent Document 1 discloses a tea beverage, which is characterized by containing tannin and caffeine, and having the ratio of the tannin content/the caffeine content being 30 or more.

Patent Document 2 discloses a beverage, which contains (A) an ester type catechin, (B) a free type catechin, and (C) caffeine, wherein the contents are:

(A)+(B)=500 to 6000 mg (I)

(A)/[(A)+(B)]=0.7 to 1.0 (II)

(A)/(C)=6 to 27. (III)

Patent Document 3 discloses a food and drink, which is characterized by containing caffeine in an amount of 0.1 weight part or less, and containing cyclodextrin in an amount of 0.1 to 20.0 weight parts with respect to 1 weight part of catechins.

### CITATION LIST

### Patent Document

Patent Document 1: Japanese Patent Application Laid-Open (JP-A) No. 2008-113569

Patent Document 2: JP-A No. 2006-67828

Patent Document 3: JP-A No. 10-4919

### DISCLOSURE OF THE INVENTION

### Problem to be Solved by the Invention

Under the circumstances where a roasted green tea beverage packed in a container has been popularized, the inventors earnestly studied a beverage that has unique taste and odor. As a result, the inventors found out that adjustments to certain conditions of the concentration of sugars, which is a sum of the concentration of monosaccharides and the concentration of disaccharides, the ratio of the concentration of disaccharides relative to the concentration of monosaccharides, and the ratio of the concentration of sugars relative to concentration of gallic acid provide a roasted green tea beverage packed in a container that has refreshing aftertaste, strong roasting flavor, and refreshing aftertaste of the roasted green tea beverage (Japanese Patent Application No. 2009-47420). On the other hand, in recent years, along with diversification of drink scene or the like, low caffeine tea beverage was demanded. However, if the content of caffeine is reduced, there is a problem that components involved in bitter astringent taste are reduced, and concentration feeling is barely sensed.

The inventors further earnestly studied, and found out that by mainly adjusting the pH and the concentration of gallic acid in the beverage, it is possible to sharpen richness of astringent taste and roasting flavor, and it is possible to provide a beverage that has concentration feeling from roasting flavor and a moderate stringent taste, and refreshing taste even when caffeine is reduced in a roasted green tea beverage packed in a container.

Therefore, the invention provides a caffeine amount-reduced roasted green tea beverage packed in a container that has sharpened roasting flavor, and has richness of astringent taste, and also has refreshing taste, and particularly can be drunk delectably even in a cold state, by adjusting the component balance of the roasted green tea beverage.

### Means for Solving Problem

The roasted green tea beverage packed in a container of the invention is characterized by having the concentration of caffeine being less than 90 ppm; the concentration of sugars which is a sum of reducing sugars and non-reducing sugars being 60 ppm to 220 ppm; the ratio of the concentration of non-reducing sugars relative to the concentration of reducing sugars (non-reducing sugars/reducing sugars) being 5.0 to 15.0; the concentration of gallic acid being 20 ppm to 80 ppm; and the pH being 5.5 to 6.3.

As described above, the adjustments of the concentration of sugars which is a sum of reducing sugars and non-reducing sugars, the concentration ratio of reducing sugars and non-reducing sugars, concentration of gallic acid, and the pH of the beverage allows a new roasted green tea beverage packed in a container that has sharpened roasting flavor, and has astringent taste, and also has refreshing taste, and particularly can be drunk delectably even in a cold state.

### BEST MODE(S) FOR CARRYING OUT THE INVENTION

Hereinafter, one embodiment of the roasted green tea beverage packed in a container of the invention will be described. However, the invention is not limited to this embodiment.

The present roasted green tea beverage packed in a container is a tea beverage obtained by filling a liquid containing an extraction liquid or an extract that is obtained by extraction of roasted green tea leaves as a major component into a container a beverage, and is a beverage that presents red tea color. The liquid, which is a tea beverage with a unique savory odor, includes, for example, a liquid that comprises only an extraction liquid that is obtained by extraction of roasted green tea leaves, or a liquid obtained by dilution of the extraction liquid, or a liquid obtained by mixing of the tea extraction liquids with each other, or a liquid obtained by addition of an additive to any of the above-mentioned liquids, or a liquid obtained by dispersion of those dried of any of the above-mentioned liquids, and the like.

The “major component” encompasses a meaning that containing of other components is acceptable within a range of not impeding the functions of the major component. At this time, the content ratio of the major component is not specified, but an extraction liquid or an extract that is obtained by extraction of a green tea, preferably takes up 50% by mass or more, particularly 70% by mass or more, and particularly 80% by mass or more (including 100%) in the solid content concentration in the beverage.

In addition, the kind of the green tea is not particularly limited. For example, the kind of the green tea includes broadly teas that are classified as a non-fermented tea such as a steamed tea, a decocted tea, a refined green tea, a green powdered tea, a Bancha tea, a bead green tea, an oven-roasted tea, a Chinese green tea, and also encompasses a blend thereof in two kinds or more. In addition, cereals such as a brown rice, a flavor such as jasmine may be also added thereto.

One embodiment of the roasted green tea beverage packed in a container of the invention (referred to as “the present roasted green tea beverage packed in a container”) is characterized by having the concentration of sugars which is a sum of reducing sugars and non-reducing sugars being 60 ppm to 220 ppm; the ratio of the concentration of non-reducing sugars relative to the concentration of reducing sugars (non-reducing sugars/reducing sugars) being 5.0 to 15.0; the gallic acid being 20 ppm to 80 ppm; and the pH being 5.5 to 6.3.

The reducing sugar is a sugar that shows reducing properties, and forms an aldehyde group and a ketone group in an alkaline solution. The reducing sugar referred to in the present invention is glucose, fructose, cellobiose or maltose.

The non-reducing sugar is a sugar that does not show reducing properties, and the non-reducing sugar referred to in the present invention represents sucrose, stachyose, or raffinose.

The concentration of sugars which is a sum of reducing sugars and non-reducing sugars (hereinafter, referred to as the concentration of sugars.) being 60 ppm to 220 ppm allows a refreshing beverage that has a balance of taste and odor being maintained, and has sweet taste and richness, and has small bitter astringent taste and coarse taste, and the like as the aftertaste even when the roasted green tea beverage packed in a container of the invention is drunk after being stored for a long period at normal temperature, or in a cold state.

From such viewpoint, the concentration of sugars is preferably 90 ppm to 160 ppm, and particularly preferably 120 ppm to 160 ppm.

In adjustment of the concentration of sugars to the above-described range, roasting process or extraction of tea leaves may be adjusted to suitable conditions. For example, if the roasting process of tea leaves is performed strongly, sugars are decomposed and decrease, and if the tea leaves are extracted at high temperature for a long time, the sugars are decomposed and decrease. Therefore, the concentration of sugars may be adjusted by the roasting conditions and the extraction conditions of tea leaves.

Although the adjustment may be performed by addition of sugars, this has a fear of collapsing the original flavor balance of the roasted green tea beverage, so the adjustment is preferably not by addition of sugars, but by adjustment of conditions for obtaining a tea extraction liquid, and in addition, by mixing of the tea extraction liquids with each other, by addition of a tea extract, or the like.

In addition, if the ratio of the concentration of non-reducing sugars relative to the concentration of reducing sugars (non-reducing sugars/reducing sugars) is 5.0 to 15.0, it allows a beverage that has strong unique top odor note of a roasted green tea, and has enjoyable odor sensed in the aftertaste.

From such viewpoint, the ratio of the concentration of non-reducing sugars relative to the concentration of reducing sugars (non-reducing sugars/reducing sugars) is preferably 6.0 to 14.0, and particularly preferably 8.0 to 14.0.

In adjustment of the ratio of the concentration of non-reducing sugars relative to the concentration of reducing sugars to the above-described range, the roasting process of tea leaves or extraction may be adjusted to suitable conditions. For example, if the roasting process of tea leaves is performed, reducing sugars decrease first, and then non-reducing sugars decrease. Thus, by performing strong roasting of tea leaves and performing extraction at high temperature for a short time, or the like, it is possible to lower the ratio of non-reducing sugars/reducing sugars.

Although the adjustment may be performed by addition of sugars, this has a fear of collapsing the balance of the roasted green tea beverage, so the adjustment is preferably not by addition of sugars, but by adjustment of conditions for obtaining a tea extraction liquid, and in addition, by mixing of the tea extraction liquids with each other, or by addition of a tea extract, or the like.

The concentration of gallic acid in the present roasted green tea beverage packed in a container being 20 ppm to 80 ppm allows a delicious beverage that has a balance of odor and astringent taste being maintained, and has no bitter, strong astringent taste, and has moderate concentration feeling, and has robust feel of residual odor in the aftertaste.

From such viewpoint, the concentration of gallic acid is preferably 30 ppm to 70 ppm, and particularly preferably 35 ppm to 65 ppm.

Furthermore, the “gallic acid” is a trivial name of 3,4,5-trihydroxybenzene carbonic acid.

In adjustment of the concentration of gallic acid to the above-described range, the roasting process of tea leaves or extraction may be adjusted to suitable conditions. For example, the concentration of gallic acid can be elevated by roasting at high temperature or alkaline extraction at high temperature.

The ratio of the concentration of sugars relative to the concentration of gallic acid (sugars/gallic acid) in the present roasted green tea beverage packed in a container is preferably is 0.75 to 10.0. When the ratio is within this range, it allows a beverage that has a balance of sweet taste and astringent taste being maintained and has excellent aftertaste.

From such viewpoint, the ratio of the concentration of sugars relative to the concentration of gallic acid (sugars/gallic acid) is more preferably 1.0 to 8.0, and particularly preferably 2.0 to 7.0.

In adjustment of the ratio of the concentration of sugars relative to the concentration of gallic acid to the above-described range, suitable conditions may be set up considering the facts that saccharides are decomposed, and the concentration of gallic acid increases with strong roasting conditions, and that saccharides are decomposed with extraction at high temperature, and the like.

The concentration of total catechins in the present roasted green tea beverage packed in a container is preferably 90 ppm to 330 ppm.

The concentration of total catechins is more preferably 100 ppm to 270 ppm, and particularly preferably 120 ppm to 240 ppm.

At this time, the total catechins represent total 8 kinds of catechins (C), gallocatechins (GC), catechins gallate (Cg), gallocatechins gallate (GCg), epicatechins (EC), epigallocatechins (EGC), epicatechins gallate (ECg), and epigallocatechins gallate (EGCg), and the concentration of the total catechins represent total values of the concentrations of the 8 kind catechins.

In adjustment of the concentration of total catechins to the above-described range, the concentration of total catechins may be adjusted by selection of raw materials, extraction conditions, or the like. Although the adjustment may be performed by addition of catechins, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The concentration of ester type catechins in the present roasted green tea beverage packed in a container is preferably 75 ppm to 200 ppm. The ester type catechins is a component that mainly senses astringent taste, and when the concentration is within such range, it allows a beverage that has richness of moderate astringent taste.

The concentration of ester type catechins is more preferably 100 ppm to 180 ppm, and particularly preferably 120 ppm to 180 ppm. Furthermore, the “ester type catechins” represents total four kinds of epigallocatechins gallate (EGCg), gallocatechins gallate (GCg), epicatechins gallate (ECg), and catechins gallate (Cg).

In adjustment of the concentration of ester type catechins to the above-described range, the concentration of ester type catechins may be adjusted by selection of raw materials, extraction conditions, or the like. However, if the temperature is too high or the extraction time is too long, it is not preferable in view of retaining flavor balance of a beverage. Although the adjustment may be performed by addition of ester type catechins, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The ratio of the concentration of ester type catechins relative to the concentration of sugars (ester type catechins/sugars) in the present roasted green tea beverage packed in a container is preferably 0.3 to 3.3. When the ratio is within this range, it allows a delicious beverage that has a balance of astringent taste and sweet taste and has a balance of roasting flavors spreading in the mouth when drunk in a cold state.

From such viewpoint, the ratio of the concentration of ester type catechins relative to the concentration of sugars (ester type catechins/sugars) is more preferably 0.7 to 2.8, and particularly preferably 0.8 to 2.4.

In adjustment of the ratio of the concentration of ester type catechins relative to the concentration of sugars to the above-described range, the ratio may be adjusted with extraction conditions or the like. However, although the extraction rate of catechins increases at high temperature, sugars are likely to be decomposed, and thus the extraction time is preferably short. Although the adjustment may be performed by addition of ester type catechins and sugars, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The concentration of caffeine in the present roasted green tea beverage packed in a container is less than 90 ppm. Caffeine is generally contained in 110 ppm to 250 ppm in a conventional green tea beverage packed in a container. However, the caffeine amount of less than 90 ppm alleviates a physiological influence on a person. From such viewpoint, the concentration of caffeine is more preferably 5 ppm to 85 ppm, and particularly preferably 10 ppm to 70 ppm.

In adjustment of the concentration of caffeine to the above-described range, the concentration of caffeine may be adjusted by blowing hot water to tea leaves, or immersing tea leaves in hot water to elute caffeine in the tea leaves, and prepare tea extraction liquids using the tea leaves, and mix the tea extraction liquids with each other. In addition, the extraction liquid may be subjected to an adsorbent such as activated carbon and white clay, whereby to adsorb and remove caffeine.

The ratio of the concentration of total catechins relative to the concentration of caffeine (total catechins/caffeine) in the present roasted green tea beverage packed in a container is preferably 1.0 to 300.

The ratio of the concentration of total catechins relative to the concentration of caffeine (total catechins/caffeine) is more preferably 2.0 to 200, and particularly preferably 4.0 to 180.

In adjustment of the ratio of the concentration of total catechins relative to the concentration of caffeine to the above-described range, the ratio may be adjusted with the above-described caffeine reducing treatment, the amount of tea leaves, and extraction temperature. Although the adjustment may be performed by addition of total catechins, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The concentration of the soluble solid content derived from the tea leaves in the present roasted green tea beverage packed in a container is preferably 0.15 to 0.40%. Furthermore, the soluble solid content derived from the tea leaves refers to a sucrose-converted value of the soluble solid content obtained by extraction of the roasted green tea.

The concentration of the soluble solid content derived from the tea leaves in the present roasted green tea beverage packed in a container is more preferably 0.16 to 0.38%, and particularly preferably 0.17 to 0.35%.

In adjustment of the concentration of the soluble solid content derived from the tea leaves to the above-described range, the concentration may be suitably adjusted with the amount of tea leaves and extraction conditions.

The ratio of the concentration of sugars relative to the concentration of the soluble solid content derived from tea leaves (sugars/(the soluble solid content derived from the tea leaves×100)) in the present roasted green tea beverage packed in a container is preferably is 1.5 to 15.0.

The ratio of the concentration of sugars relative to the concentration of the soluble solid content derived from tea leaves is more preferably 2.0 to 12.0, and particularly preferably 2.5 to 10.0.

In adjustment of the ratio of the concentration of sugars relative to the concentration of the soluble solid content derived from tea leaves to the above-described range, the solid content concentration may be elevated by increasing the amount of tea leaves, and the ratio may be adjusted with a combination of the amount of tea leaves and roasting conditions for the raw tea. At this time, although the adjustment may be performed by addition of sugars, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The ratio of the concentration of total catechins relative to the concentration of the soluble solid content derived from tea leaves (total catechins/(the soluble solid content derived from the tea leaves×100)) in the present roasted green tea beverage packed in a container is preferably 2.5 to 20.0.

The ratio of the concentration of total catechins relative to the concentration of the soluble solid content derived from tea leaves is more preferably 3.0 to 18.0, and particularly preferably 3.5 to 16.0.

In adjustment of the ratio of the concentration of total catechins relative to the concentration of the soluble solid content derived from tea leaves to the above-described range, the ratio may be adjusted with roasting conditions and extraction conditions. Although the adjustment may be performed by addition of catechins, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The ratio of ester type catechins relative to the concentration of the soluble solid content derived from tea leaves (ester type catechins/(the soluble solid content derived from the tea leaves×100)) in the present roasted green tea beverage packed in a container is preferably 2.0 to 16.0. When the ratio is within this range, it allows a delicious beverage that has a balance of roasting flavor and astringent taste, and also has afterglow of odor when drunk in a cold state.

From such viewpoint, the ratio of the concentration of ester type catechins relative to the concentration of the soluble solid content derived from tea leaves is more preferably 2.8 to 14.0, and particularly preferably 3.0 to 12.0.

In adjustment of the ratio of the concentration of ester type catechins relative to the concentration of the soluble solid content derived from tea leaves to the above-described range, the ratio may be adjusted with roasting conditions, extraction conditions such as extraction temperature, or the like. Although the adjustment may be performed by addition of ester type catechins, this has a fear of collapsing the balance of the roasted green tea beverage, so the adjustment is preferably performed by adjustment of conditions for obtaining a tea extraction liquid, and in addition, by mixing of the tea extraction liquids with each other, by addition of a tea extract, or the like.

The pH in the present roasted green tea beverage packed in a container is 5.5 to 6.3 at 20° C. The adjustment of the pH to being somewhat weak acidic as described above allows a delicious refreshing beverage that has a balance of odor and astringent taste, and that does not sense strong acid taste, and has no astringent taste that becomes unpleasant aftertaste, and has a balance of top odor note and odor remaining in the aftertaste and concentration feeling, and has good aftertaste and robust feel.

From such viewpoint, the pH in the present roasted green tea beverage packed in a container is preferably 5.7 to 6.2, and particularly preferably 5.8 to 6.1. In adjustment of the pH to the above-described range, for example, the amount of a pH adjusting agent such as ascorbic acid and sodium bicarbonate may be adjusted.

The concentrations of reducing sugars, non-reducing sugars, gallic acid, ester type catechins, total catechins, and caffeine described above can be measured by a calibration curve method or the like with use of high performance liquid chromatogram (HPLC) or the like. The concentration of the soluble solid content derived from tea leaves can be measured by a differential concentration meter.

In addition, the pH can be measured with a pH meter.

(Container)

A container to be filled with the present roasted green tea beverage packed in a container is not particularly limited. For example, a plastic-made bottle (so-called PET bottle), a can made of a metal such as steel and aluminum, a bottle, a paper container, or the like may be used, and particularly, a transparent container such as a PET bottle or the like may be preferably used as the container.

(Manufacturing Method)

The above-described roasted green tea beverage packed in a container may be manufactured by, for example, selecting raw materials for tea leaves; suitably adjusting dry (fire) process of tea leaves and extraction conditions;

adjusting the concentration of sugars which is a sum of reducing sugars and non-reducing sugars in the beverage to 60 ppm to 220 ppm; adjusting the ratio of the concentration of non-reducing sugars relative to the concentration of reducing sugars (non-reducing sugars/reducing sugars) to 5.0 to 15.0; adjusting the concentration of gallic acid to 20 ppm to 80 ppm; and adjusting the pH to 5.5 to 6.3.

For example, the present roasted green tea beverage packed in a container may be manufactured by preparing an extraction liquid, which is obtained by blowing hot water shower of 70° C. to 100° C. to tea leaves for 60 to 180 seconds to elute caffeine, roasting the tea leaves at 200° C. to 380° C., and extracting the tea leaves at high temperature for a short time; preparing a conventional, general roasted green tea extraction liquid, i.e., an extraction liquid that is obtained by subjecting tea leaves to roasting process at 180° C. to 360° C. and extracting the tea leaves at high temperature for a short time, and then blending them in a suitable ratio. However, the manufacturing method is not limited to such manufacturing method.

Furthermore, as described above, if the roasting process of tea leaves is performed, reducing sugars decrease first, and then non-reducing sugars decrease. Accordingly, by adjustment of the conditions for the roasting process, the concentration of sugars, or the value of non-reducing sugars/reducing sugars may be adjusted.

(Explanation For Terms)

The “roasted green tea beverage” in the present invention means a beverage containing a tea extraction liquid or tea extract that is obtained from tea extraction, as a major component.

In addition, the “roasted green tea beverage packed in a container” means a roasted green tea beverage packed in a container, but also means a roasted green tea beverage that may be drunk without dilution.

When “X to Y” (X and Y are any number) is expressed in the present specification, it encompasses the meaning of “X or more and Y or less”, and also the meaning of “preferably greater than X” and “preferably less than Y” unless otherwise stated.

### EXAMPLES

Hereinafter, Examples of the present invention will be explained. However, the present invention is not limited to these Examples.

Furthermore, the “concentration of reducing sugars” in Examples means a total concentration of glucose, fructose, cellobiose, and maltose, and the “concentration of non-reducing sugars” means a total concentration of sucrose, stachyose, and raffinose.

<Evaluation Test>

Extraction Liquids A to F described below were prepared, and using these Extraction Liquids, roasted green tea beverages of Examples 1 to 7 and Comparative Examples 1 to 5 were prepared, and sensory evaluations thereof were performed.

(Extraction Liquid A)

Tea leaves (Yabukita species, first flush tea produced in Shizuoka Prefecture) after plucking were subjected to Aracha process, and subjected to roasting process under the conditions of 350° C. of the setting temperature and 5 minutes of the roasting time with a rotation drum type roasting machine, and the tea leaves were extracted under the conditions of 12 g of the tea leaves, 1 L of 90° C. hot water, and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (Σ), to prepare Extraction Liquid A listed in Table 1 described below.

(Extraction Liquid B)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by TERADA SEISAKUSHO, Ltd. The tea leaves were subjected to Aracha process, and to a dry process (fire process) under the conditions of 200° C. of the setting temperature and 30 minutes of the dry time with a rotation drum type drying machine. The tea leaves were extracted under the conditions of 8 g of the tea leaves, 1 L of 50° C. warm water, and 5.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid B listed in Table 1 described below.

(Extraction Liquid C)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by TERADA SEISAKUSHO, Ltd. The tea leaves were subjected to Aracha process, and to a dry process (fire process) under the conditions of 300° C. of the setting temperature and 10 minutes of the dry time with a rotation drum type drying machine. The tea leaves were extracted under the conditions of 7 g of the tea leaves, 1 L of 65° C. warm water, and 7 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid C listed in Table 1 described below.

(Extraction Liquid D)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by TERADA SEISAKUSHO, Ltd. The tea leaves were subjected to Aracha process, and to a dry process (fire process) under the conditions of 350° C. of the setting temperature, and 5 minutes of the dry time with a rotation drum type drying machine. The tea leaves were extracted under the conditions of 12 g of the tea leaves, 1 L of 90° C. hot water, and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid D listed in Table 1 described below.

(Extraction Liquid E)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by TERADA SEISAKUSHO, Ltd. The tea leaves were subjected to Aracha process, and to a dry process (fire process) under the conditions of 370° C. of the setting temperature, and 3 minutes of the dry time with a rotation drum type drying machine. The tea leaves were extracted under the conditions of 13 g of the tea leaves, 1 L of 90° C. hot water, and 3.5 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid E listed in Table 1 described below.

(Extraction Liquid F)

Tea leaves (Yabukita species, first flush tea produced in Shizuoka Prefecture) after plucking were subjected to low caffeine treatment with application of about 95° C. hot water shower for about 2 minutes with use of a caffeine reducing machine of hot water shower manufactured by Terada seisakusho., Ltd. The tea leaves were subjected to Aracha process, and to a dry process (fire process) under the conditions of 310° C. of the setting temperature and 10 minutes of the dry time with a rotation drum type drying machine. The tea leaves were extracted under the conditions of 8 g of the tea leaves, 1 L of 90° C. hot water, and 10 minutes of the extraction time. This extraction liquid was filtered with a stainless mesh (20 mesh) to remove the tea grounds, and then further filtered with a stainless mesh (80 mesh). The filtrate was centrifugally isolated with use of SA1 continuous centrifugal isolator (manufactured by Westphalia) under the conditions of 300 L/h of the flow rate, 10000 rpm of the rotation number, and 1000 m² of the centrifugal sedimentation liquid area (s), to prepare Extraction Liquid F listed in Table 1 described below.

(Analysis of Extraction Liquids) 1/10 amount of each the above-described an extraction liquids was weighed, added with ascorbic acid in 400 ppm, and then added with sodium bicarbonate to adjust pH to 6.2, and added with ion-exchanged water to adjust the total amount to 100 mL. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C. and measured for analysis of the components of each extraction liquid.

The results of the analyses are presented in Table 1 described below. Furthermore, the measurement method is as described below.

TABLE 1

| | | | | | | | Soluble solid | | | | |
|---|---|---|---|---|---|---|---|---|---|---|---|
| | | | [symbol] type | | Gallic | | content derived | | Extraction | Extraction | Amount of tea |
| | | | extraction | Caffeine | acid | Total | from tea leaves | Condition for | temperature | time | leaves [symbol] |
| | [symbol] | [symbol] | [symbol] | [symbol] | [symbol] | [symbol] | (%) | roasting | (° C.) | (minutes) | (g/l) |
| Extraction | 11.55 | 160.0 | 228.8 | 158.2 | 64.4 | [symbol] | [symbol] | Firing at 350° C | 90 | 5.5 | [symbol] |
| Liquid A | | | | | | | | for 5 minutes | | | |
| Extraction | 7.28 | 87.8 | 266.3 | 68.3 | 19.8 | 328.3 | 0.21 | Firing at 200° C | 50 | 5.5 | 8 |
| Liquid B | | | | | | | | for 30 minutes | | | |
| Extraction | 26.85 | 142.1 | 229.8 | 56.9 | 64.7 | 231.8 | 0.18 | Firing at 300° C | [symbol] | 7 | [symbol] |
| Liquid C | | | | | | | | for 20 minutes | | | |
| Extraction | 22.15 | 158.2 | 224.3 | 79.1 | 68.8 | 232.9 | 0.29 | Firing at 350° C | 90 | [symbol] | [symbol] |
| Liquid D | | | | | | | | for 5 minutes | | | |
| Extraction | 4.28 | 108.5 | 67.8 | 77.9 | 81.3 | 119.8 | 0.28 | Firing at 370° C | 90 | [symbol] | 13 |
| Liquid E | | | | | | | | for [symbol] minutes | | | |
| Extraction | 16.76 | [symbol] | [symbol] | [symbol] | [symbol] | [symbol] | 0.18 | Firing at 340° C | 90 | 10 | [symbol] |
| Liquid F | | | | | | | | for 10 minutes | | | |

[symbol]

indicates data missing or illegible when filed

(Blending)

Extraction Liquids A to F were blended in the ratios illustrated in Table 2 described below, added with ascorbic acid in 400 ppm, and then added with sodium bicarbonate to suitably adjust pH, and added with ion-exchanged water to adjust the total amount to 1000 ml. This liquid was filled into a heat-resistant transparent container (bottle) and capped, and over-turn sterilized for 30 seconds. The sterilization was performed to 9 or more of F₀ value for retort sterilization (121° C., 9 minutes), and the solution was immediately cooled to 20° C., to prepare the roasted green tea beverages of Examples 1 to 7 and Comparative Examples 1 to 5.

TABLE 2

| | | | | | | | | Compar- | Compar- | Compar- | Compar- | Compar- |
|---|---|---|---|---|---|---|---|---|---|---|---|---|
| | Exam- | Exam- | Exam- | Exam- | Exam- | Exam- | Exam- | ative | ative | ative | ative | ative |
| | ple 1 | ple 2 | ple 3 | ple 4 | ple 5 | ple 6 | ple 7 | Example 1 | Example 2 | Example 3 | Example 4 | Example 5 |
| Extraction | 0 | 0 | 0 | 10 | 0 | 0 | 10 | 0 | 0 | 0 | 0 | 0 |
| Liquid A | | | | | | | | | | | | |
| Extraction | 30 | 0 | 0 | 90 | 0 | 0 | 90 | 0 | 0 | 100 | 0 | 0 |
| Liquid B | | | | | | | | | | | | |
| Extraction | 0 | 15 | 0 | 0 | 0 | 0 | 0 | 0 | 0 | 0 | 0 | 20 |
| Liquid C | | | | | | | | | | | | |
| Extraction | 0 | 0 | 100 | 0 | 100 | 100 | 0 | 100 | 100 | 0 | 0 | 0 |
| Liquid D | | | | | | | | | | | | |
| Extraction | 0 | 85 | 0 | 0 | 0 | 0 | 0 | 0 | 0 | 0 | 100 | 0 |
| Liquid E | | | | | | | | | | | | |
| Extraction | 70 | 0 | 0 | 0 | 0 | 0 | 0 | 0 | 0 | 0 | 0 | 80 |
| Liquid F | | | | | | | | | | | | |
| Total | 100 | 100 | 100 | 100 | 100 | 100 | 100 | 100 | 100 | 100 | 100 | 100 |

(Analysis of Examples and Comparative Examples)

Components and pH of the roasted green tea beverages of Examples 1 to 7 and Comparative Examples 1 to 5 were measured as listed below. The results are listed in Table 3 described below.

TABLE 3

| | | | | | | | | Compar- | Compar- | Compar- | Compar- | Compar- |
|---|---|---|---|---|---|---|---|---|---|---|---|---|
| | Exam- | Exam- | Exam- | Exam- | Exam- | Exam- | Exam- | ative | ative | ative | ative | ative |
| | ple 1 | ple 2 | ple 3 | ple 4 | ple 5 | ple 6 | ple 7 | Example 1 | Example 2 | Example 3 | Example 4 | Example 5 |
| [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] |
| [symbol] type [symbol] | [symbol] | [symbol] | [symbol] | [symbol] | [symbol] | [symbol] | [symbol] | [symbol] | [symbol] | [symbol] | [symbol] | [symbol] |
| pH (20° C.) | [symbol] | [symbol] | [symbol] | [symbol] | [symbol] | [symbol] | [symbol] | [symbol] | [symbol] | [symbol] | [symbol] | [symbol] |
| Caffeine [symbol] | [symbol] | [symbol] | [symbol] | [symbol] | [symbol] | [symbol] | [symbol] | [symbol] | [symbol] | [symbol] | [symbol] | [symbol] |
| Gallic acid [symbol] | [symbol] | [symbol] | [symbol] | [symbol] | [symbol] | [symbol] | [symbol] | [symbol] | [symbol] | [symbol] | [symbol] | [symbol] |
| Total extraction [symbol] | [symbol] | [symbol] | [symbol] | [symbol] | [symbol] | [symbol] | [symbol] | [symbol] | [symbol] | [symbol] | [symbol] | [symbol] |
| Soluble solid content | [symbol] | 0.26 | 0.29 | [symbol] | [symbol] | [symbol] | [symbol] | [symbol] | [symbol] | [symbol] | [symbol] | [symbol] |
| derived from tea | | | | | | | | | | | | |
| leaves (%) | | | | | | | | | | | | |
| [symbol] | [symbol] | [symbol] | [symbol] | [symbol] | [symbol] | [symbol] | [symbol] | Δ | [symbol] | [symbol] | [symbol] | [symbol] |
| [symbol] | [symbol] | [symbol] | [symbol] | [symbol] | [symbol] | [symbol] | [symbol] | Δ | [symbol] | [symbol] | x | x |
| [symbol] | [symbol] | [symbol] | [symbol] | [symbol] | [symbol] | [symbol] | [symbol] | Δ | x | x | x | x |
| Acid [symbol] | [symbol] | [symbol] | ∘ | ∘ | ∘ | Δ | [symbol] | [symbol] | x | [symbol] | [symbol] | [symbol] |
| Concentration [symbol] | [symbol] | [symbol] | [symbol] | [symbol] | [symbol] | [symbol] | [symbol] | [symbol] | [symbol] | ∘ | [symbol] | [symbol] |
| [symbol] | [symbol] | [symbol] | [symbol] | [symbol] | [symbol] | [symbol] | [symbol] | x | x | x | x | x |
| [symbol] | [symbol] | [symbol] | [symbol] | [symbol] | [symbol] | [symbol] | [symbol] | Δ | Δ | Δ | x | x |

[symbol]

indicates data missing or illegible when filed

The concentration of reducing sugars and the concentration of non-reducing sugars were quantity-measured by a calibration curve method with manipulation of a HPLC sugar analysis equipment (manufactured by Dionex Corporation) under the conditions described below.

Column: Carbopack PA1 φ4.6×250 mm manufactured by Dionex Corporation

Column temperature: 30° C.

Mobile Phase:
Phase A 200 mM NaOH
Phase B 1000 mM Sodium Acetate
Phase C Ultrapure water

Flow Rate: 1.0 mL/min

Injection Amount: 25 μL

Detection: ED50 gold electrode manufactured by Dionex Corporation

The concentration of of gallic acid, the concentration of ester type catechins, the concentration of total catechins, and the concentration of caffeine were quantity-measured by a calibration curve method with manipulation of a high performance liquid chromatogram (HPLC) under the conditions described below.

Column: Xbridge shield RP18 φ3.5×150 mm manufactured by Waters Corporation

Column Temperature: 40° C.

Mobile Phase:
Phase A Water
Phase B Acetonitrile
Phase C 1% phosphoric acid

Flow Rate: 0.5 mL/min

Injection Amount: 5 μL

Detection: UV230 nm UV detector manufactured by Waters Corporation

The pH was measured with F-24, a pH meter manufactured by HORIBA, Ltd.

An extraction liquid containing only extract of tea leaves was diluted to 1 L of the liquid amount, and the concentration of the soluble solid content derived from tea leaves was measured with a differential concentration meter DD-7 manufactured by ATAGO CO., Ltd.

(Evaluation Item)

Using the roasted green tea beverages of Examples 1 to 7 and Comparative Examples 1 to 5, the top odor note, the odor sensing in the aftertaste, the aftertaste, the acid taste, the concentration feeling, and the palatability (balance of odor and taste) were evaluated.

(Evaluation Test)

The roasted green tea beverages of Examples 1 to 7 and Comparative Examples 1 to 5 were cooled to 5° C. in a refrigerator. These roasted green tea beverages were tasted by five persons of trained examiners, and given scores by the standards as described below. The average points of the five persons were evaluated such that “⊚ (double circle)” indicates 3.5 or more, “∘ (circle)” indicates 3 or more and less than 3.5, “Δ (triangle)” indicates 2 or more and less than 3, and “x (cross)” indicates 1 or more and less than 2. The results thereof are listed in Table 3 described above.

<Top Odor Note>

Particularly Strong=4

Strong=3

Somewhat=2

Weak=1

<Odor Sensing in the Aftertaste>

Particularly Strong=4

Strong=3

Somewhat=2

Weak=1

<Aftertaste>

Very Good=4

Good=3

Usual=2

Bad=1

<Acid Taste>

Not at all=4

Slightly Sensing=3

Sensing=2

Strongly sensing=1

<Concentration Feeling>

Particularly Strong=4

Strong=3

Somewhat=2

Weak=1

<Palatability (Balance of Odor and Taste)>

Very likable=4

Likable=3

Usual=2

Dislikable=1

(Total Evaluation)

The average points of the above-described six evaluation tests were computed, and the evaluations were performed wherein “⊚ (double circle)” indicates 3.5 or more, “∘ (circle)” indicates 3 or more and less than 3.5, “Δ (triangle)” indicates 2 or more and less than 3, and “x (cross)” indicates 1 or more and less than 2 of the average point.

For any of Examples 1 to 7, excellent results were obtained, of which the total evaluation was “∘ (circle)” or better.

On the other hand, for Comparative Examples 1 to 5, the results were not preferable, in which the evaluation was “Δ (triangle)” for Comparative Examples 1 to 3, and “x (cross)” for Comparative Examples 4 and 5.

(Discussion)

From the results of Comparative Examples 1 and 2, it was found out that if the pH increases, the palatability becomes worse, and if the pH decreases, not only the palatability, but also the aftertaste is bad, and the acid taste becomes strong.

In addition, from the results of Comparative Examples 3 and 4, it was found out that if the concentration of gallic acid increases, there is bitter astringent taste and the total sensory evaluations become worse, and if the concentration of gallic acid decreases, the top odor note, the aftertaste, and the palatability become worse.

Furthermore, from the results of Comparative Examples 4 and 5, it was found out that if the value of non-reducing sugars/reducing sugars increases or decreases, the odor sensing in the aftertaste is poor, and the total sensory evaluations become worse.

From these results, it is assumed that the ranges of the concentration of caffeine being less than 90 ppm; the concentration of sugars which is a sum of reducing sugars and non-reducing sugars being 60 ppm to 220 ppm; the ratio of the concentration of non-reducing sugars relative to the concentration of reducing sugars (non-reducing sugars/reducing sugars) being 5.0 to 15.0; the concentration of gallic acid being 20 ppm to 80 ppm; and the pH being 5.5 to 6.3, are ranges that allow a roasted green tea beverage that has good evaluations of the top odor note, the odor sensing in the aftertaste, the aftertaste, the acid taste, the concentration feeling, and the palatability (balance of odor and taste). It was discovered that a roasted green tea beverage having them within such ranges provides a roasted green tea beverage that has sharpened roasting flavor, and also has richness of astringent taste, and refreshing taste, and can be drunk delectably even in a cold state.

1. A roasted green tea beverage packed in a container wherein;
a concentration of caffeine is less than 90 ppm;
a concentration of sugars, a sum of reducing sugars and non-reducing sugars is 60 ppm to 220 ppm;
a ratio of a concentration of non-reducing sugars relative to a concentration of reducing sugars (non-reducing sugars/reducing sugars) is 5.0 to 15.0;
a concentration of gallic acid is 20 ppm to 80 ppm; and,
the pH is 5.5 to 6.3.

2. A method of manufacturing a roasted green tea beverage packed in a container, comprising;
adjusting a concentration of caffeine in the roasted green tea beverage to less than 90 ppm;
adjusting a concentration of sugars, a sum of reducing sugars and non-reducing sugars to 60 ppm to 220 ppm;
adjusting a ratio of a concentration of non-reducing sugars relative to a concentration of reducing sugars (non-reducing sugars/reducing sugars) to 5.0 to 15.0; and,
adjusting a concentration of gallic acid to 20 ppm to 80 ppm; and adjusting the pH to 5.5 to 6.3.

3. A method of improving flavor of a roasted green tea beverage packed in a container, comprising;
adjusting a concentration of caffeine in the roasted green tea beverage to less than 90 ppm;
adjusting a concentration of sugars, a sum of reducing sugars and non-reducing sugars to 60 ppm to 220 ppm;
adjusting a ratio of a concentration of non-reducing sugars relative to a concentration of reducing sugars (non-reducing sugars/reducing sugars) to 5.0 to 15.0; and,
adjusting a concentration of gallic acid to 20 ppm to 80 ppm; and adjusting the pH to 5.5 to 6.3.
